(19) United States
(12) Patent Application Publication
(10) Pub. No.: US 2022/0124573 A1
(43) Pub. Date: Apr. 21, 2022

(54) APPARATUSES AND METHODS FOR RECOVERING FROM SIDELINK RELAY FAILURE

(71) Applicant: MEDIATEK INC., Hsinchu City (TW)

(72) Inventors: Chun-Fan TSAI, Hsinchu City (TW); Nathan Edward TENNY, San Jose, CA (US)

(21) Appl. No.: 17/474,313

(22) Filed: Sep. 14, 2021

Related U.S. Application Data
(60) Provisional application No. 63/093,821, filed on Oct. 20, 2020.

(51) Int. Cl. H04W 36/00; H04W 36/30; H04W 76/19

(52) U.S. Cl. CPC H04W 36/0079; H04W 36/305; H04W 92/18; H04W 76/19; H04W 36/03

(57) ABSTRACT

A method for recovering from Sidelink relay failure is provided. A relay User Equipment (UE) detects a Radio Link Failure (RLF) or a Handover (HO) failure associated with a first base station when providing a relay service for a remote UE to indirectly communicate with the first base station. The relay UE sends a first command to the remote UE to indicate suspension of the relay service. The relay UE performs a Radio Resource Control (RRC) re-establishment procedure with the first base station or a second base station based on a cell search result. The relay UE sends a second command to the remote UE to indicate that the relay service is associated with the first base station or the second base station with which the RRC re-establishment procedure is performed.

### CROSS REFERENCE TO RELATED APPLICATIONS

This application claims priority under 35 U.S.C. § 119 from U.S. Provisional Application No. 63/093,821, entitled “Methods and apparatus to recover from SL Relay RLF”, filed on Oct. 20, 2020, the subject matter of which is incorporated herein by reference.

### BACKGROUND OF THE APPLICATION

### Field of the Application

The application generally relates to mobile communications and, more particularly, to apparatuses and methods for recovering from Sidelink relay failure.

### Description of the Related Art

In a typical mobile communication environment, User Equipment (UE) (also called Mobile Station (MS)), such as a mobile telephone (also known as a cellular or cell phone), or a tablet Personal Computer (PC) with wireless communications capability, may communicate voice and/or data signals to one or more mobile communication networks. The wireless communications between the UE and the mobile communication networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc.

These RATs have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In 5G NR, Device-to-Device (D2D) communication is supported to allow two or more UEs to directly communicate with one another. This D2D communication may also be referred to as SideLink (SL) communication, and it may be applied to vehicular communication services which are also known as Vehicle-to-Everything (V2X) services. V2X collectively refers to communication technology via all interfaces with vehicles, including Vehicle-to-Vehicle (V2V), Vehicle-to-Infrastructure (V2I), Vehicle-to-Person (V2P), and Vehicle-to-Network (V2N).

Particularly, in some cases, a UE may have data to exchange with a 5G network but they may not be able to communicate with each other directly, due to physical distance or obstructions (e.g., the UE is outside of the radio signal coverage of the 5G network and is generally referred to as a remote UE). For use in such situations, a UE-to-network relaying design is contemplated, in which another UE within the radio signal coverage of the 5G network may serve as a relay to forward data between the remote UE and the 5G network. Specifically, the relay UE connected to the base station over the Uu interface may serve one or more remote UEs over the PC5 interface, extending network coverage to the remote UEs through SL communication.

However, due to the specifications for SL relaying still being under discussion among 3GPP members, many details are not yet identified, including how to continue the relay service when a Radio Link Failure (RLF) or Handover (HO) failure occurs over the Uu interface and the PC5 interface between the relay UE and the remote UE is still usable.

### BRIEF SUMMARY OF THE APPLICATION

In order to solve the aforementioned problem, the present application proposes specific ways for coordinating the operations of the relay UE and the remote UE to recover from the RLF or HO failure over the Uu interface. In particular, control signaling commands dedicated for synchronizing the status of the relay service between the relay UE and the remote UE is introduced in the coordinated operations of the relay UE and the remote UE.

In a first aspect of the application, a method is provided. The method comprises the following steps: detecting, by a relay UE, an RLF or a HO failure associated with a first base station when providing a relay service for a remote UE to indirectly communicate with the first base station; sending, by the relay UE, a first command to the remote UE to indicate suspension of the relay service; performing, by the relay UE, a Radio Resource Control (RRC) re-establishment procedure with the first base station or a second base station based on a cell search result; and sending, by the relay UE, a second command to the remote UE to indicate that the relay service is associated with the first base station or the second base station with which the RRC re-establishment procedure is performed.

In one embodiment of the first aspect of the application, the method further comprises the following steps: forwarding, by the relay UE, an RRC re-establishment request message from the remote UE to the second base station in response to the relay service being associated with the second base station; receiving, by the relay UE, an RRC reconfiguration message comprising Radio Bearer (RB) mapping configuration for the relay service from the second base station; sending, by the relay UE, a Sidelink RRC Reconfiguration message comprising the RB mapping configuration to the remote UE; and using, by the relay UE, the RB mapping configuration to forward data between the remote UE and the second base station.

In one embodiment of the first aspect of the application, the first command or the second command is sent in a PC5 RRC message or a control Protocol Data Unit (PDU) of a PC5 adaptation layer.

In one embodiment of the first aspect of the application, the first command or the second command is sent as a broadcast to all remote UEs or as a multicast to specific remote UEs.

In one embodiment of the first aspect of the application, the second command comprises at least one of the following: a cell Identifier (ID) of the first base station or the second base station that is associated with the relay service; and configuration of a radio resource pool for Sidelink communication, which is obtained from a System Information Block (SIB) or an RRC reconfiguration message received from the second base station.

In one embodiment of the first aspect of the application, the method further comprises the following steps: buffering, by the relay UE, data from the remote UE in response to the RLF or the HO failure; and forwarding, by the relay UE, the buffered data to the first base station or the second base station when the relay service is resumed.

In a second aspect of the application, a relay UE comprising a wireless transceiver and a controller is provided. The wireless transceiver is configured to perform wireless transmission and reception to and from a remote UE and a first base station or a second base station. The controller is configured to: configured to detect an RLF or an HO failure associated with the first base station via the wireless transceiver when providing a relay service for the remote UE to indirectly communicate with the first base station, send a first command to the remote UE via the wireless transceiver to indicate suspension of the relay service, perform an RRC re-establishment procedure with the first base station or a second base station via the wireless transceiver based on a cell search result, and send a second command to the remote UE via the wireless transceiver to indicate that the relay service is associated with the first base station or the second base station with which the RRC re-establishment procedure is performed.

In one embodiment of the second aspect of the application, the controller is further configured to forward an RRC re-establishment request message from the remote UE to the second base station via the wireless transceiver in response to the relay service being associated with the second base station, receive an RRC reconfiguration message comprising RB mapping configuration for the relay service from the second base station via the wireless transceiver, send a Sidelink RRC Reconfiguration message comprising the RB mapping configuration to the remote UE via the wireless transceiver, and use the RB mapping configuration to forward data between the remote UE and the second base station via the wireless transceiver.

In one embodiment of the second aspect of the application, the first command or the second command is sent in a PC5 RRC message or a control PDU of a PC5 adaptation layer.

In one embodiment of the second aspect of the application, the first command or the second command is sent as a broadcast to all remote UEs or as a multicast to specific remote UEs.

In one embodiment of the second aspect of the application, the second command comprises at least one of the following: a cell ID of the first base station or the second base station that is associated with the relay service; and configuration of a radio resource pool for Sidelink communication, which is obtained from a SIB or an RRC reconfiguration message received from the second base station.

In one embodiment of the second aspect of the application, the controller is further configured to buffer data from the remote UE in response to the RLF or the HO failure, and forward the buffered data to the first base station or the second base station via the wireless transceiver when the relay service is resumed.

In a third aspect of the application, a method is provided. The method comprises the following steps: receiving, by a remote UE, a first command from a relay UE when using a relay service of the relay UE to indirectly communicate with a first base station via the relay UE, wherein the first command indicates suspension of the relay service; suspending, by the remote UE, the relay service in response to the first command; receiving, by the remote UE, a second command from the relay UE, wherein the second command indicates that the relay service is associated with the first base station or a second base station; and resuming, by the remote UE, the relay service in response to the second command.

In one embodiment of the third aspect of the application, the method further comprises the following steps: sending, by the remote UE, an RRC re-establishment request message to the second base station via the relay UE in response to the second command indicating that the relay service is associated with the second base station; receiving, by the remote UE, a Sidelink RRC Reconfiguration message from the relay UE, wherein the Sidelink RRC Reconfiguration message comprises RB mapping configuration for the relay service associated with the second base station from the relay UE; and using, by the remote UE, the RB mapping configuration to resume the relay service associated with the second base station.

In one embodiment of the third aspect of the application, the first command or the second command is received in a PC5 RRC message or a control PDU of a PC5 adaptation layer.

In one embodiment of the third aspect of the application, the second command comprises at least one of the following: a cell ID of the first base station or the second base station that is associated with the relay service; and configuration of a radio resource pool for Sidelink communication, which is obtained from a SIB or an RRC reconfiguration message received from the second base station.

In one embodiment of the third aspect of the application, the remote UE uses configuration of an exceptional radio resource pool for Sidelink communication in response to receiving the first command, and uses the configuration of the radio resource pool for Sidelink communication in response to receiving the second command.

In one embodiment of the third aspect of the application, the method further comprises the following steps: buffering, by the remote UE, data that is sent to but not acknowledged by the first base station; and resending, by the remote UE, the buffered data to the first base station or the second base station when the relay service is resumed.

In one embodiment of the third aspect of the application, the method further comprises: reselecting, by the remote UE, another relay UE or another base station to obtain data service after receiving the first command.

In one embodiment of the third aspect of the application, the method further comprises: starting, by the remote UE, a timer when receiving the first command; wherein the reselecting of another relay UE or another base station is performed in response to the timer expiring before receiving the second command.

Other aspects and features of the present application will become apparent to those with ordinarily skill in the art upon review of the following descriptions of specific embodiments of the apparatuses and methods for recovering from Sidelink relay failure.

### BRIEF DESCRIPTION OF THE DRAWINGS

The present application can be more fully understood by reading the subsequent detailed description and examples with references made to the accompanying drawings, wherein:

FIG. 1 is a schematic diagram illustrating a mobile communication network according to an embodiment of the application;

FIG. 2 is a schematic diagram illustrating a UE-to-network relaying scenario according to an embodiment of the application;

FIG. 3 is a schematic diagram illustrating a layer 2 UE-to-network relaying architecture according to an embodiment of the application;

FIG. 4 is a schematic diagram illustrating a layer 2 UE-to-network relaying architecture according to another embodiment of the application;

FIG. 5 is a block diagram illustrating a UE according to an embodiment of the application;

FIGS. 6A and 6B show a message sequence chart of recovering from Sidelink relay failure according to an embodiment of the application;

FIG. 7 is a flow chart illustrating the method for recovering from Sidelink relay failure from the perspective of a relay UE according to an embodiment of the application; and

FIG. 8 is a flow chart illustrating the method for recovering from Sidelink relay failure from the perspective of a remote UE according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

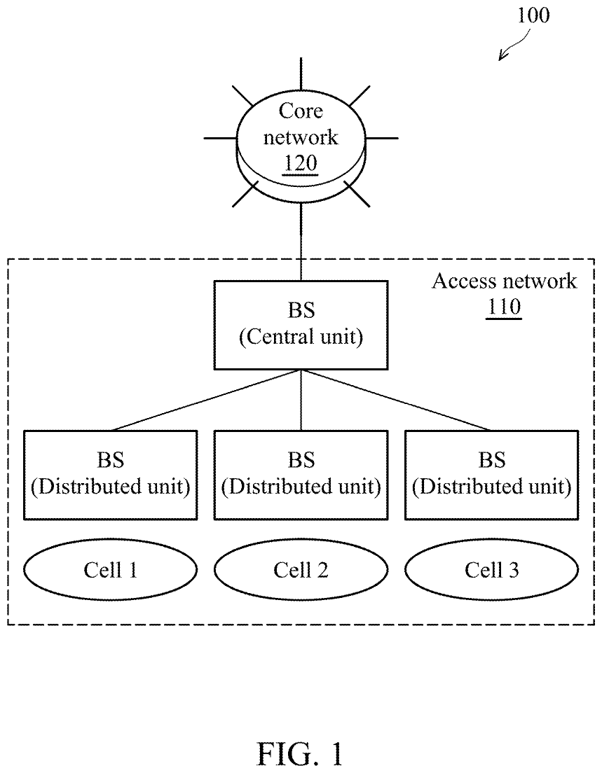

FIG. 1 is a schematic diagram illustrating a mobile communication network according to an embodiment of the application.

As shown in FIG. 1, the mobile communication network 100 may include an access network 110 and a core network 120. The access network 110 may be responsible for processing radio signals, terminating radio protocols, and connecting one or more UEs (not shown) with the core network 120. The core network 120 may be responsible for performing mobility management, network-side authentication, and interfaces with public/external networks (e.g., the Internet).

In one embodiment, the mobile communication network 100 may be a 5G NR network, and the access network 110 and the core network 120 may be a Next Generation Radio Access Network (NG-RAN) and a Next Generation Core Network (NG-CN) (or called 5GC), respectively.

An NG-RAN may include one or more Base Stations (BSs), such as next generation NodeBs (gNBs), which support high frequency bands (e.g., above 24 GHz), and each gNB may further include one or more Transmission Reception Points (TRPs), wherein each gNB or TRP may be referred to as a 5G BS. Some gNB functions may be distributed across different TRPs, while others may be centralized, leaving the flexibility and scope of specific deployments to fulfill the requirements for specific cases. For example, different protocol split options between central unit and distributed unit of gNB nodes may be possible. In one embodiment, the Service Data Adaptation Protocol (SDAP) layer and the Packet Data Convergence Protocol (PDCP) layer may be located in the central unit, while the Radio Link Control (RLC) layer, the Medium Access Control (MAC) layer, and the Physical (PHY) layer may be located in the distributed units.

A 5G BS may form one or more cells with different Component Carriers (CCs) for providing mobile services to UEs. For example, a UE may camp on one or more cells formed by one or more gNBs or TRPs, wherein the cells which the UE is camped on may be referred to as serving cells.

A NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

It should be understood that the mobile communication network 100 described in the embodiment of FIG. 1 is for illustrative purposes only and is not intended to limit the scope of the application. For example, the RAT utilized by the mobile communication network 100 may be a legacy technology, such as the LTE, LTE-A, or TD-LTE technology, or may be a future enhancement of the 5G NR technology, such as the 6G technology.

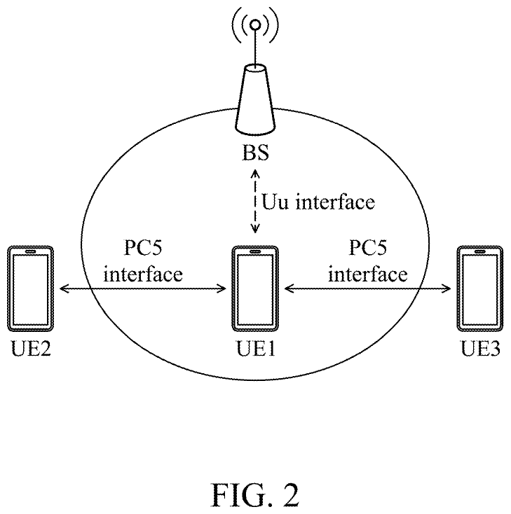

FIG. 2 is a schematic diagram illustrating a UE-to-network relaying scenario according to an embodiment of the application.

As shown in FIG. 2, UE1 is located within the radio coverage of the BS and is able to communicate with the BS over the Uu interface, while UE2 and UE3 are outside of the radio coverage of the BS. In addition to supporting the Uu interface, UE1 also supports the PC5 interface for SL communication with UE2 and UE3.

Specifically, the Uu interface refers to the logical interface between the UE and the BS, while the PC5 interface refers to a reference point where two UEs directly communicate with each other over the direct channel.

UE1 may operate as a relay UE which schedules/allocates the radio resources for UE2 and UE3 (or called remote UEs) according to the configuration received from the BS or pre-defined in the 3GPP specifications for NR-based V2X. As a relay, UE1 may forward data between UE2 and UE3, and/or forward data between UE2/UE3 and the BS. For example, UE1 may be configured as a Layer 2 relay or a Layer 3 relay. Alternatively, UE1 may not operate as a relay, and may initiate direct SL communication with either one or both of UE2 and UE3.

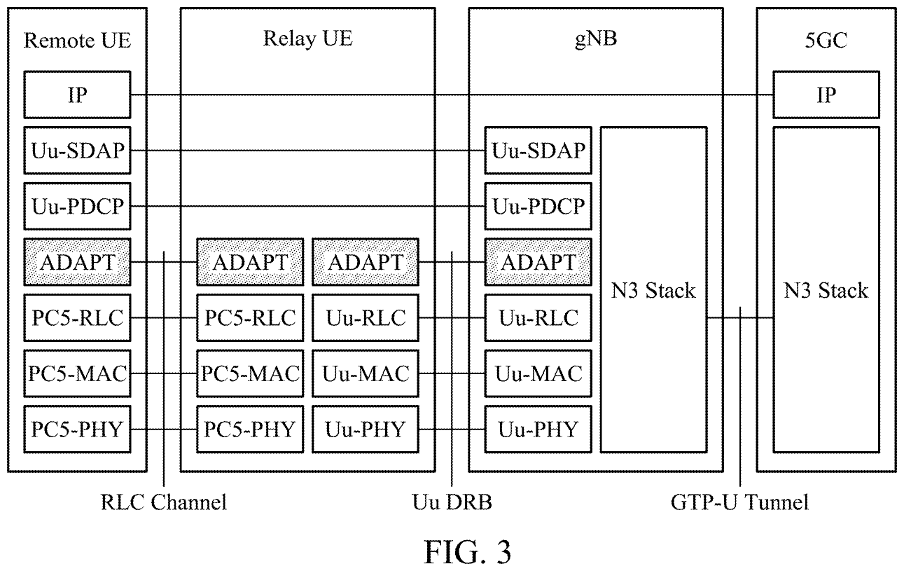

FIG. 3 is a schematic diagram illustrating a layer 2 UE-to-network relaying architecture according to an embodiment of the application.

As shown in FIG. 3, the user-plane protocol stack for a remote UE may include a Service Data Adaptation Protocol (SDAP) layer, a Packet Data Convergence Protocol (PDCP) layer, an adaptation (ADAPT) layer, a Radio Link Control (RLC) layer, a Media Access Control (MAC) layer, and a Physical (PHY) layer. All these layers, except for the ADAPT layer, may be modeled on those already developed in release 16 of the 3GPP specifications for NR-based V2X. The ADAPT layer is specific to the relaying environment, and has the function of mapping upper-layer bearers to lower-layer channels in a way that supports forwarding by the relay UE. In particular, the SDAP and PDCP layers are end-to-end (i.e., terminated between the remote UE and the gNB), while the ADAPT, RLC, MAC, and PHY layers are hop-by-hop (i.e., terminated between the remote UE and the relay UE).

Although not shown, the control-plane protocol stacks for such UE-to-network relaying architecture may be similar, with the exception that the SDAP layer should be omitted and a control protocol layer, such as a PC5 Radio Resource Control (PC5-RRC) layer, should be added on top of the PDCP layer.

It should be understood that the protocol stacks shown in FIG. 3 are for illustrative purposes only and are not intended to limit the scope of the application. For example, the protocol stacks may be replicated across different sets of UEs, so that, a single relay UE may have multiple peer remote UEs, in any combination of correspondences with each other.

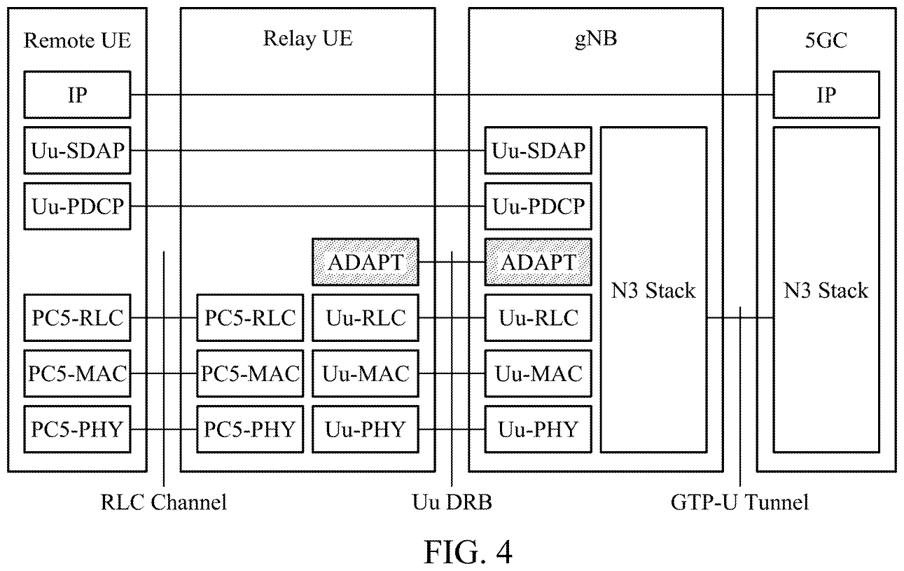

FIG. 4 is a schematic diagram illustrating a layer 2 UE-to-network relaying architecture according to another embodiment of the application.

As shown in FIG. 4, the user-plane protocol stacks for the UE-to-network relaying architecture is similar to those in the embodiment of FIG. 3, with the exception that there is no ADAPT layer in the PC5 interface between the remote UE and the relay UE. It implies that one to one mapping between PC5 RLC entities of Relay and Remote UE.

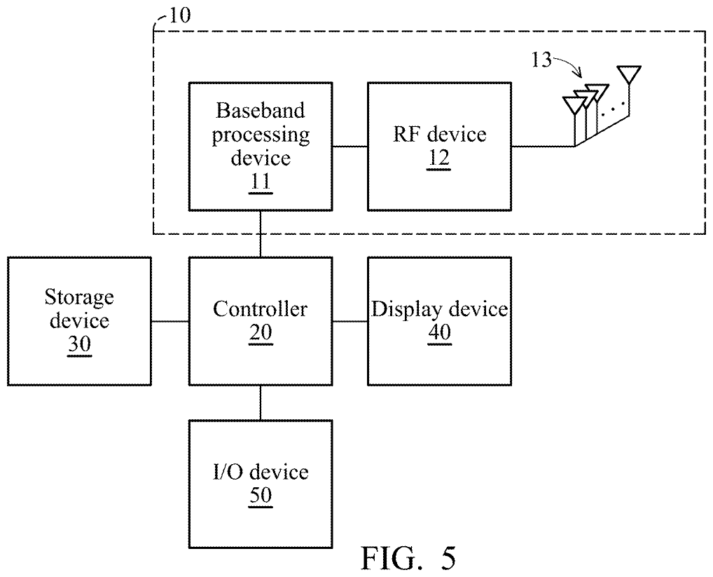

FIG. 5 is a block diagram illustrating a UE according to an embodiment of the application.

As shown in FIG. 5, a UE (e.g., a relay UE or a remote UE) may include a wireless transceiver 10, a controller 20, a storage device 30, a display device 40, and an Input/Output (I/O) device 50.

The wireless transceiver 10 is configured to perform wireless transmission and reception to and from one or more peer UEs over the PC5 interface and/or a BS over the Uu interface.

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between subscriber identity card(s) (not shown) and the RF device 12. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may comprise a mixer to multiply the baseband signals with a carrier oscillated in the radio frequency of the supported RAT(s), wherein the radio frequency may be any radio frequency (e.g., 30 GHz-300 GHz for mmWave) utilized in the 5G NR technology, or may be 900 MHz, 2100 MHz, or 2.6 GHz utilized in LTE/LTE-A/TD-LTE technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communication over the Uu interface and/or the PC5 interface, storing and retrieving data (e.g., program code) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 for performing the method of the present application.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application. For example, the communication protocols may include a 5G NR protocol stacks which includes a Non-Access-Stratum (NAS) layer to communicate with an AMF/SMF/MME entity connecting to the core network 120, a Radio Resource Control (RRC) layer for high layer configuration and control, an SDAP layer, a PDCP layer, an ADAPT layer, an RLC layer, a MAC layer, and a PHY layer.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 5 are for illustrative purposes only and are not intended to limit the scope of the application. For example, a UE may include more components, such as a power supply, and/or a Global Positioning System (GPS) device, wherein the power supply may be a mobile/replaceable battery providing power to all the other components of the UE, and the GPS device may provide the location information of the UE for use by some location-based services or applications. Alternatively, a UE may include fewer components. For example, a UE may not include the display device 40 and/or the I/O device 50.

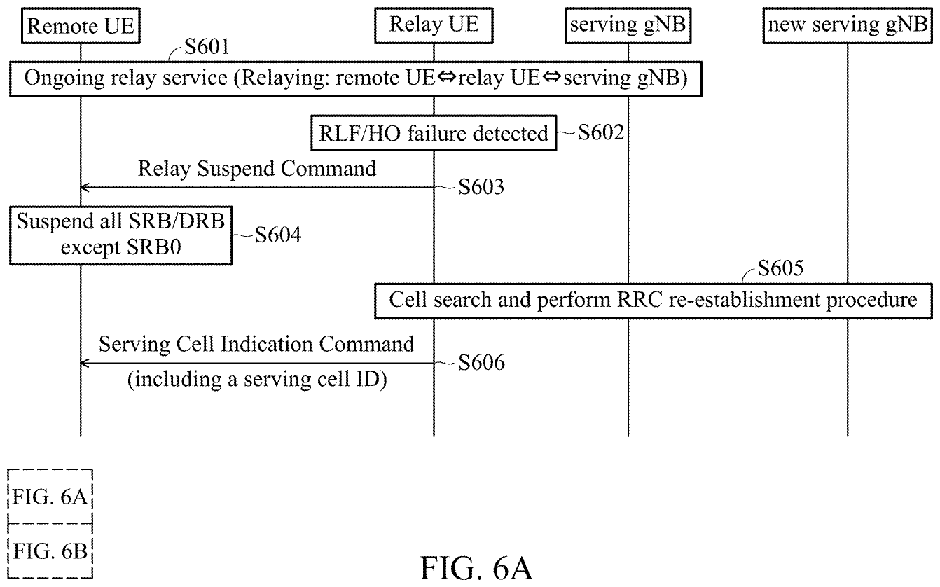

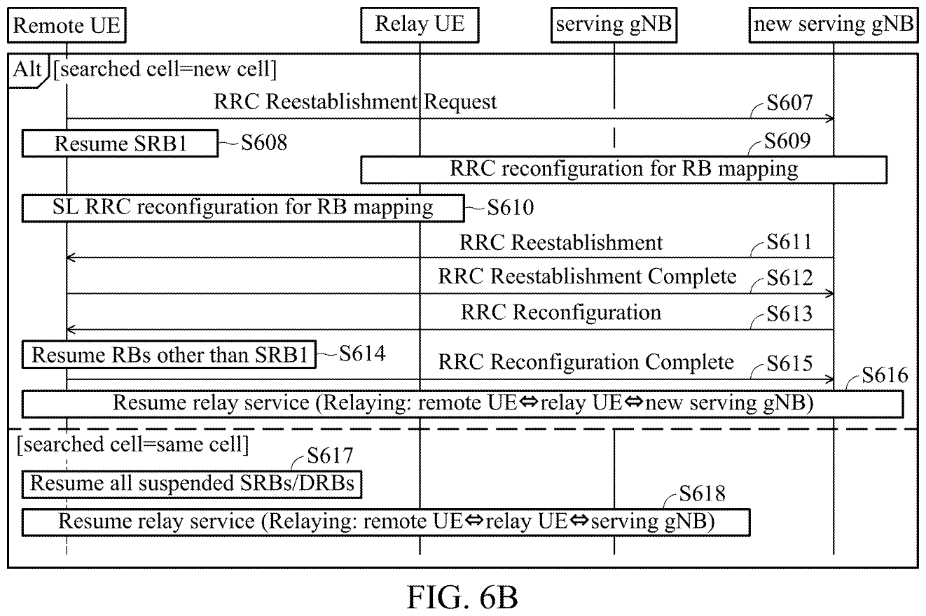

FIGS. 6A and 6B show a message sequence chart of recovering from Sidelink relay failure according to an embodiment of the application.

In step S601, a relay service is ongoing to allow the remote UE to communicate with the serving gNB via the relay UE.

In step S602, the relay UE detects an RLF or an HO failure over the Uu interface. Specifically, the RLF may refer to the situation where the relay UE experiences interference and/or poor signal strength leading to disconnection with the serving gNB, and the HO failure may refer to the situation where the relay UE fails to establish a connection with the target gNB during a handover from the serving gNB to the target gNB.

In step S603, the relay UE sends a Relay Suspend Command to the remote UE. Specifically, the Relay Suspend Command indicates suspension of the relay service. In one example, the Relay Suspend Command may be sent in a PC5 RRC message or a control Protocol Data Unit (PDU) of the PC5 adaptation layer. In one example, the Relay Suspend Command may be sent as a broadcast to all remote UEs or as a multicast to a specific remote UEs.

In step S604, the remote UE suspends all Signaling Radio Bearers (SRBs) and Data Radio Bearers (DRBs) except SRB0 (i.e., suspends the relay service). That is, the remote UE stops sending data to the relay UE.

In step S605, the relay UE searches for a suitable cell and performs an RRC re-establishment procedure on the searched suitable cell. Specifically, the searched suitable cell may be a new cell formed by another gNB (denoted as new serving gNB in FIG. 6A), or may be the same cell form by the serving gNB, depending on the cell search result.

In step S606, the relay UE sends a Serving Cell Indication Command to the remote UE to indicate the serving cell associated with the relay service (i.e., to indicate that the relay service is associated with the searched suitable cell). Specifically, the Serving Cell Indication Command may include a cell Identifier (ID) of the searched suitable cell. In one example, if the searched suitable cell is a new cell formed by another gNB, the Serving Cell Indication Command may include the configuration of the radio resource pool for Sidelink communication, which is obtained from a System Information Block (SIB) (e.g., SIB12) or an RRC Reconfiguration message received from the new cell. Specifically, the RRC Reconfiguration message may be the first reconfiguration after the RRC re-establishment procedure.

Please note that the following steps S607˜S616 are performed only for the case where the searched suitable cell is a new cell formed by the new serving gNB. That is, if the searched suitable cell is the same cell formed by the old serving gNB, step S617 is performed subsequent to step S606.

In step S607, the remote UE sends an RRC Reestablishment Request message on SRB0 to the new serving gNB via the relay UE.

In step S608, the remote UE resumes SRB1 after sending the RRC Reestablishment Request message.

In step S609, the relay UE performs an RRC reconfiguration procedure with the new serving gNB. During the RRC reconfiguration procedure, the relay UE may receive an RRC Reconfiguration message from the new serving gNB. The RRC Reconfiguration message includes the RB mapping configuration for the relay service to be recovered. The RB mapping configuration at least includes the RB mapping configuration of SRB1. Alternatively, the RB mapping configuration may include the RB mapping configuration of other RBs as well. The RB mapping configuration may be used by the relay UE to forward data between the remote UE and the new serving gNB, when the relay service is back on with the new serving gNB.

In step S610, the relay UE performs an SL RRC reconfiguration procedure with the remote UE. During the SL RRC reconfiguration procedure, the relay UE may send a Sidelink RRC Reconfiguration message to the remote UE. The Sidelink RRC Reconfiguration message includes the RB mapping configuration from the new serving gNB.

In step S611, once SRB1 relay is setup, the new serving gNB sends an RRC Reestablishment message to the remote UE via the relay UE.

In step S612, the remote UE replies to the new serving gNB with an RRC Reestablishment Complete message via the relay UE. Note that the remote UE's action regarding key derivation upon reception of the RRC Reestablishment message may be the same as specified for the legacy RRC re-establishment procedure over the Uu interface according to the 3GPP specifications for NR-based V2X.

In step S613, the new serving gNB sends an RRC Reconfiguration message to the remote UE to resume RBs other than SRB1.

In step S614, the remote UE resumes RBs other than SRB1.

In step S615, the remote UE sends an RRC Reconfiguration Complete message to the new serving gNB.

In step S616, the remote UE resumes the relay service associated with the new serving gNB after resuming all RBs.

In step S617, for the case where the searched suitable cell is the same cell formed by the old serving gNB, the remote UE resumes all suspended SRBs and DRBs when receiving the Serving Cell Indication Command including the cell ID of the same serving cell.

In step S618, the remote UE resumes the relay service associated with the same serving gNB after resuming all RBs.

Although not shown in FIGS. 6A˜6B, it should be noted that the data from the remote UE is unable to be forwarded to the network during the relay service recovering period, and thus, a retransmission mechanism is required. In one example, the relay UE may buffer the data from the remote UE, and forward the buffered data to the new/old serving gNB when the relay service is resumed. In another example, the remote UE may buffer the data that is sent to but not acknowledged by the old serving gNB, and resend the data to the new/old serving gNB when the relay service is resumed.

Instead of waiting for the relay service recovery, the remote UE may reselect another relay UE or another base station to obtain data service after receiving the Relay Suspend Command. For example, the remote UE may start a guard timer when receiving the Relay Suspend Command, and reselect another relay UE or another base station in response to the guard timer expiring before receiving the Serving Cell Indication Command.

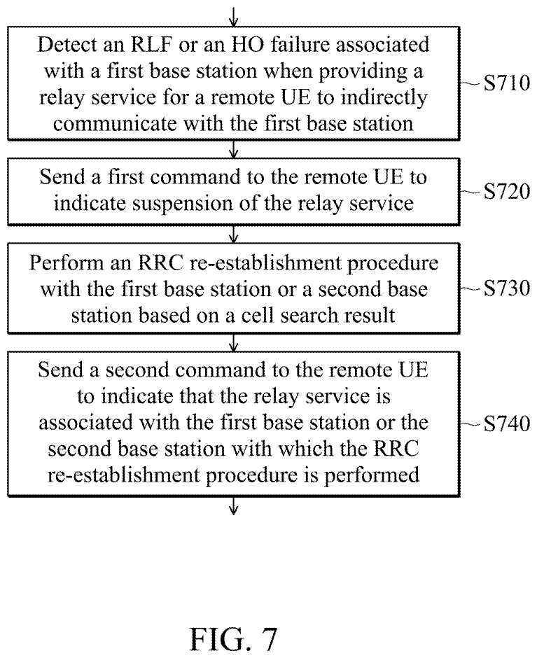

FIG. 7 is a flow chart illustrating the method for recovering from Sidelink relay failure from the perspective of a relay UE according to an embodiment of the application.

In step S710, the relay UE detects an RLF or an HO failure associated with a first base station when providing a relay service for a remote UE to indirectly communicate with the first base station.

In step S720, the relay UE sends a first command (e.g., a Relay Suspend Command) to the remote UE to indicate suspension of the relay service.

In step S730, the relay UE performs an RRC re-establishment procedure with the first base station or a second base station based on a cell search result.

In step S740, the relay UE sends a second command (e.g., a Serving Cell Indication Command) to the remote UE to indicate that the relay service is associated with the first base station or the second base station with which the RRC re-establishment procedure is performed.

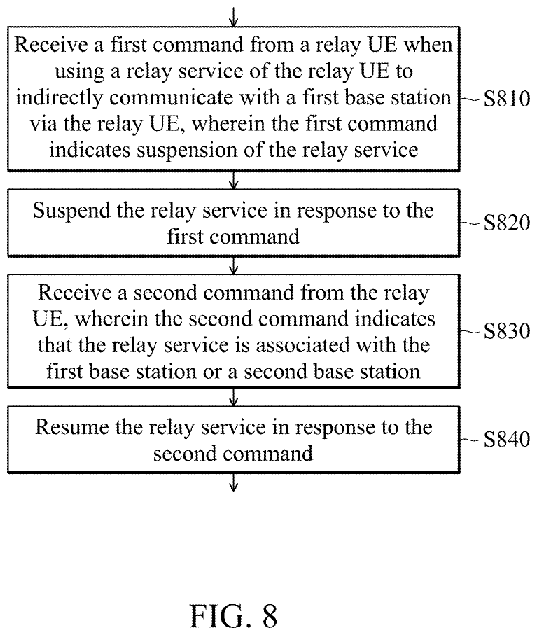

FIG. 8 is a flow chart illustrating the method for recovering from Sidelink relay failure from the perspective of a remote UE according to an embodiment of the application.

In step S810, the remote UE receives a first command (e.g., a Relay Suspend Command) from a relay UE when using a relay service of the relay UE to indirectly communicate with a first base station via the relay UE, wherein the first command indicates suspension of the relay service.

In step S820, the remote UE suspends the relay service in response to the first command.

In step S830, the remote UE receives a second command (e.g., a Serving Cell Indication Command) from the relay UE, wherein the second command indicates that the relay service is associated with the first base station or a second base station.

In step S840, the remote UE resumes the relay service in response to the second command.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A method, comprising:
detecting, by a relay User Equipment (UE), a Radio Link Failure (RLF) or a Handover (HO) failure associated with a first base station when providing a relay service for a remote UE to indirectly communicate with the first base station;
sending, by the relay UE, a first command to the remote UE to indicate suspension of the relay service;
performing, by the relay UE, a Radio Resource Control (RRC) re-establishment procedure with the first base station or a second base station based on a cell search result; and
sending, by the relay UE, a second command to the remote UE to indicate that the relay service is associated with the first base station or the second base station with which the RRC re-establishment procedure is performed.

2. The method as claimed in claim 1, further comprising:
forwarding, by the relay UE, an RRC re-establishment request message from the remote UE to the second base station in response to the relay service being associated with the second base station;
receiving, by the relay UE, an RRC reconfiguration message comprising Radio Bearer (RB) mapping configuration for the relay service from the second base station;
sending, by the relay UE, a Sidelink RRC Reconfiguration message comprising the RB mapping configuration to the remote UE; and
using, by the relay UE, the RB mapping configuration to forward data between the remote UE and the second base station.

3. The method as claimed in claim 1, wherein the first command or the second command is sent in a PC5 RRC message or a control Protocol Data Unit (PDU) of a PC5 adaptation layer.

4. The method as claimed in claim 1, wherein the first command or the second command is sent as a broadcast to all remote UEs or as a multicast to specific remote UEs.

5. The method as claimed in claim 1, wherein the second command comprises at least one of the following:
a cell Identifier (ID) of the first base station or the second base station that is associated with the relay service; and
configuration of a radio resource pool for Sidelink communication, which is obtained from a System Information Block (SIB) or an RRC reconfiguration message received from the second base station.

6. The method as claimed in claim 1, further comprising:
buffering, by the relay UE, data from the remote UE in response to the RLF or the HO failure; and
forwarding, by the relay UE, the buffered data to the first base station or the second base station when the relay service is resumed.

7. A relay UE, comprising:
a wireless transceiver, configured to perform wireless transmission and reception to and from a remote UE and a first base station or a second base station; and
a controller, configured to detect an RLF or an HO failure associated with the first base station via the wireless transceiver when providing a relay service for the remote UE to indirectly communicate with the first base station, send a first command to the remote UE via the wireless transceiver to indicate suspension of the relay service, perform an RRC re-establishment procedure with the first base station or a second base station via the wireless transceiver based on a cell search result, and send a second command to the remote UE via the wireless transceiver to indicate that the relay service is associated with the first base station or the second base station with which the RRC re-establishment procedure is performed.

8. The relay UE as claimed in claim 7, wherein the controller is further configured to forward an RRC re-establishment request message from the remote UE to the second base station via the wireless transceiver in response to the relay service being associated with the second base station, receive an RRC reconfiguration message comprising RB mapping configuration for the relay service from the second base station via the wireless transceiver, send a Sidelink RRC Reconfiguration message comprising the RB mapping configuration to the remote UE via the wireless transceiver, and use the RB mapping configuration to forward data between the remote UE and the second base station via the wireless transceiver.

9. The relay UE as claimed in claim 7, wherein the first command or the second command is sent in a PC5 RRC message or a control PDU of a PC5 adaptation layer.

10. The relay UE as claimed in claim 7, wherein the first command or the second command is sent as a broadcast to all remote UEs or as a multicast to specific remote UEs.

11. The relay UE as claimed in claim 7, wherein the second command comprises at least one of the following:
a cell ID of the first base station or the second base station that is associated with the relay service; and
configuration of a radio resource pool for Sidelink communication, which is obtained from a SIB or an RRC reconfiguration message received from the second base station.

12. The relay UE as claimed in claim 7, wherein the controller is further configured to buffer data from the remote UE in response to the RLF or the HO failure, and forward the buffered data to the first base station or the second base station via the wireless transceiver when the relay service is resumed.

13. A method, comprising:
receiving, by a remote UE, a first command from a relay UE when using a relay service of the relay UE to indirectly communicate with a first base station via the relay UE, wherein the first command indicates suspension of the relay service;
suspending, by the remote UE, the relay service in response to the first command;
receiving, by the remote UE, a second command from the relay UE, wherein the second command indicates that the relay service is associated with the first base station or a second base station; and
resuming, by the remote UE, the relay service in response to the second command.

14. The method as claimed in claim 13, further comprising:
sending, by the remote UE, an RRC re-establishment request message to the second base station via the relay UE in response to the second command indicating that the relay service is associated with the second base station;
receiving, by the remote UE, a Sidelink RRC Reconfiguration message from the relay UE, wherein the Sidelink RRC Reconfiguration message comprises RB mapping configuration for the relay service associated with the second base station from the relay UE; and
using, by the remote UE, the RB mapping configuration to resume the relay service associated with the second base station.

15. The method as claimed in claim 13, wherein the first command or the second command is received in a PC5 RRC message or a control PDU of a PC5 adaptation layer.

16. The method as claimed in claim 13, wherein the second command comprises at least one of the following:
a cell ID of the first base station or the second base station that is associated with the relay service; and
configuration of a radio resource pool for Sidelink communication, which is obtained from a SIB or an RRC reconfiguration message received from the second base station.

17. The method as claimed in claim 16, wherein the remote UE uses configuration of an exceptional radio resource pool for Sidelink communication in response to receiving the first command, and uses the configuration of the radio resource pool for Sidelink communication in response to receiving the second command.

18. The method as claimed in claim 13, further comprising:
buffering, by the remote UE, data that is sent to but not acknowledged by the first base station; and
resending, by the remote UE, the buffered data to the first base station or the second base station when the relay service is resumed.

19. The method as claimed in claim 13, further comprising:
reselecting, by the remote UE, another relay UE or another base station to obtain data service after receiving the first command.

20. The method as claimed in claim 19, further comprising:
starting, by the remote UE, a timer when receiving the first command;
wherein the reselecting of another relay UE or another base station is performed in response to the timer expiring before receiving the second command.
